(19) United States
(12) Patent Application Publication
(10) Pub. No.: US 2025/0105626 A1
(43) Pub. Date: Mar. 27, 2025

(54) GRID-FORMING ENERGY STORAGE CONVERTER ON/OFF-GRID SWITCHING CONTROL METHOD AND SYSTEM

(71) Applicants: State Grid Hunan electric Power Company Limited, Changsha (CN); Electric Power Research Institute of State Grid Hunan Electric Power Company, Changsha (CN); State Grid Corporation of China, Changsha (CN); Hunan Xiangdian TEST&RESEARCH Institute Co., Ltd., Changsha (CN)

(72) Inventors: Haiguo TANG, Changsha (CN); Kehui ZHOU, Changsha (CN); Jiran ZHU, Changsha (CN); Tong KANG, Changsha (CN); Yong WANG, Changsha (CN); Lingchao KONG, Changsha (CN); Hengyi ZHOU, Changsha (CN); Fei QI, Changsha (CN); Hui XIAO, Changsha (CN); Mei SU, Changsha (CN); Yandong CHEN, Changsha (CN); Zhijie LIAN, Changsha (CN); Di ZHANG, Changsha (CN); Zhidan ZHANG, Changsha (CN); Lei REN, Changsha (CN)

(73) Assignees: State Grid Hunan electric Power Company Limited, Changsha (CN); Electric Power Research Institute of State Grid Hunan Electric Power Company, Changsha (CN); State Grid Corporation of China, Changsha (CN); Hunan Xiangdian TEST & RESEARCH Institute Co., Ltd., Changsha (CN)

(21) Appl. No.: 18/958,790

(22) Filed: Nov. 25, 2024

Related U.S. Application Data
(63) Continuation of application No. PCT/CN2024/075489, filed on Feb. 2, 2024.

(30) Foreign Application Priority Data
Sep. 21, 2023 (CN) 2023112281560

(51) Int. Cl. H02J 3/24; G05B 11/42; H02J 3/18

(52) U.S. Cl. CPC H02J 3/24; G05B 11/42; H02J 3/1835

(57) ABSTRACT

The present invention relates to the technical field of power electronics converters and discloses a grid-forming energy storage converter on/off-grid switching control method and system, where the method includes the following steps: S1: using a single-loop power control strategy in an off-grid state when an on-grid relay of target energy storage drops out; S2: using a parallel virtual impedance loop-based power control strategy in a transient on-grid state when the on-grid relay of target energy storage pulls in; and S3: using a cascaded dual-loop power control strategy with a virtual admittance voltage loop and an inner current loop when a stable on-grid state is established. The present invention solves the problems of large current impact and unstable switching process state in the existing working strategy for on/off-grid switching in the prior art.

### CROSS-REFERENCE TO RELATED APPLICATIONS

The application claims priority to Chinese patent application No. 2023112281560, filed on Sep. 21, 2023, the entire contents of which are incorporated herein by reference.

### TECHNICAL FIELD

The present invention relates to the technical field of power electronics converters, and in particular, to a grid-forming energy storage converter on/off-grid switching control method and system.

### BACKGROUND

With the rapid development of power electronics converter technology, three-level energy storage converters are increasingly used in power grids. As a type of grid-forming energy storage converter, the three-level energy storage converter's working strategy for on/off-grid switching mainly includes: using a single-loop power control strategy in an off-grid state; applying a pre-synchronization algorithm when it is detected that the grid voltage is within a normal range; achieving consistent voltage amplitude and phase between the converter and the grid during a pre-synchronization link; and using a cascaded voltage and current dual-loop power control strategy in an on-grid state when an on-grid relay pulls in. At present, when carrying out the above working strategy, the converter immediately switches from the single-loop power control strategy to the cascaded voltage and current dual-loop power control strategy after the on-grid relay pulls in, which will result in a huge current impact, thereby shortening the service life of components and even triggering current protection and causing shutdown in serious cases. It can be seen that the existing working strategy for on/off-grid switching in the prior art has problems of large current impact and unstable switching process state.

### SUMMARY

The present invention provides a grid-forming energy storage converter on/off-grid switching control method and system to solve the problems of large current impact and unstable switching process state in the existing working strategy for on/off-grid switching in the prior art.

In order to achieve the above objectives, the present invention is implemented through the following technical solution:

in a first aspect, the present invention provides a grid-forming energy storage converter on/off-grid switching control method, including the following steps:

S1: using a single-loop power control strategy in an off-grid state when an on-grid relay of target energy storage drops out;

S2: using a parallel virtual impedance loop-based power control strategy in a transient on-grid state when the on-grid relay of target energy storage pulls in, where a frequency domain expression of the virtual impedance loop is Rv+sLv, Rv represents a virtual resistance, Lv represents a virtual inductance, s represents the Laplacian operator, and sLv constitutes a differential term of the virtual impedance loop; and

S3: using a cascaded dual-loop power control strategy with a virtual admittance voltage loop and an inner PI current loop when a stable on-grid state is established.

Optionally, the single-loop power control strategy includes:

an active frequency control loop and a reactive voltage control loop;

an implementation manner of the active frequency control loop is as follows: an output of a difference between a reference frequency ω_{ref} and a control frequency ω after passing through a Dₚ link is superimposed with a difference between a reference active power P_{ref} and an actual output active power P, and then passes through an inertia integration link 1/Js to generate a control frequency ω; a phase reference value θ of a converter output voltage is generated by integrating ω, where the active frequency control loop simulates a rotor motion equation and a primary frequency modulation process of a synchronous machine, the rotor motion equation includes an inertia J and a damping Dₚ, and the primary frequency modulation process includes a droop Dₚ; and

an implementation manner of the reactive voltage control loop is as follows: an output of a difference between a reference AC voltage amplitude V_{ref} and an actual AC voltage amplitude V after passing through a D_{q} link is superimposed with a difference between a reference reactive power Q_{ref} and an actual output reactive power Q, and then passes through an integration link 1/Ks to generate an internal potential amplitude E.

Optionally, the single-loop power control strategy includes:

detecting a grid voltage under the single-loop power control strategy, and when a value of the grid voltage is within a preset normal range, carrying out a pre-synchronization algorithm and achieving consistent voltage amplitude and phase between a target converter and the grid in the pre-synchronization algorithm.

Optionally, an implementation manner of the pre-synchronization algorithm is as follows: a phase angle θ_{g} of a grid voltage v_{gabc} is obtained through a phase-locked loop; the grid voltage v_{gabc} in an abc coordinate system is transformed according to the phase angle θ_{g} to obtain v_{gd} and v_{gq} in a dq coordinate system, and a converter output voltage v_{abc} in the abc coordinate system is transformed according to the phase angle θ_{g} to obtain v_{d} and v_{q} in the dq coordinate system; an output ΔV of a difference between v_{gd} and v_{d} after passing through a PI controller is superimposed into a reactive loop to change V_{ref}−V to V_{ref}−V+ΔV; and an output Δω of a difference between v_{gq} and v_{q} after passing through the PI controller is superimposed onto an output end of an active loop integration link 1/Js.

Optionally, the parallel virtual impedance loop-based power control strategy includes:

superimposing a current i_{sabc} flowing through a machine-side inductor L₁ onto a power loop output e_{abc} through a virtual impedance loop Rᵥ+sLᵥ to generate a three-phase modulated wave v_{mabc}.

Optionally, the cascaded dual-loop power control strategy with a virtual admittance voltage loop and an inner current loop includes:

enabling a difference between a power loop output e_{abc} and a converter output voltage v_{sabc} to pass through a virtual admittance voltage loop 1/(Rₛ+sLₛ) to generate a reference current i_{refabc}, and enabling a difference between the reference current i_{refabc} and a machine-side current i_{sabc} to pass through a current controller Gᵢ(s) and get superimposed with control quantities of active damping and grid voltage feedforward links to generate a three-phase modulated wave v_{mabc}, where the current controller Gᵢ(s) includes a proportional controller, a resonant controller, and a repetitive controller.

In a second aspect, the present invention provides a grid-forming energy storage converter on/off-grid switching control system, including a processor and a non-transitory memory, where:

the non-transitory memory is configured to store a computer program; and

the processor is configured to implement any one of the steps of the method of the first aspect when executing the computer program stored on the non-transitory memory.

### Beneficial Effects

According to the grid-forming energy storage converter on/off-grid switching control method and system provided by the present invention, the virtual impedance loop is introduced in the transient on-grid state, and the parallel virtual impedance loop-based power control strategy is used, where the frequency domain expression of the virtual impedance loop is Rv+sLv, and the differential term sLᵥ is very sensitive to interference. Therefore, the introduction of the virtual impedance loop can provide transient damping and reduce current impact at the moment of on-grid connection. Since the differential term sLᵥ can easily cause system malfunction and affect system stability in a stable on-grid state, the virtual impedance loop is removed and the cascaded dual-loop power control strategy with a virtual admittance voltage loop and an inner PI current loop is introduced when a stable on-grid state is established. It can be seen that the present invention optimizes the system stability and response speed by dynamically adjusting the virtual impedance loop in the transient on-grid state, which is different from the fixed virtual impedance method in the prior art and simple in algorithm implementation. Moreover, the virtual impedance is equivalent to an equivalent impedance connected in series between the converter and the grid, which can provide a damping effect with a fast response in the transient state to greatly reduce and suppress on-grid current impact and enhance the transient stability of the converter during the off-grid to on-grid switching process.

### BRIEF DESCRIPTION OF THE DRAWINGS

FIG. 1 is a flowchart of a grid-forming energy storage converter on/off-grid switching control method of an exemplary embodiment of the present invention; and

FIGS. 2A and 2B is schematic diagram of a grid-forming energy storage converter on/off-grid switching control method of an exemplary embodiment of the present invention.

### DETAILED DESCRIPTION OF THE EMBODIMENTS

The technical solution of the present invention will be clearly and completely described below with reference to the accompanying drawings. Obviously, the described embodiments are only some but not all of the embodiments of the present invention. All other embodiments obtained by a person of ordinary skill in the art based on the embodiments of the present invention without creative efforts shall fall within the protection scope of the present invention.

Unless otherwise defined, the technical or scientific terms used in the present invention shall have the common meanings as understood by those skilled in the art to which the present invention belongs. The terms “first”, “second”, and the like used in the present invention are not intended to indicate any sequence, amount or importance, but distinguish different components. Also, the terms such as “a”, “an”, and the like are not intended to limit the amount, but indicate the existence of at least one. As used herein, “connection”, “connected”, and the like are not limited to a physical or mechanical connection but may include a direct or indirect electrical connection. “Upper”, “lower”, “left”, “right”, and the like are only used to indicate a relative position relationship, and when the absolute position of the described object changes, the relative position relationship may be changed accordingly.

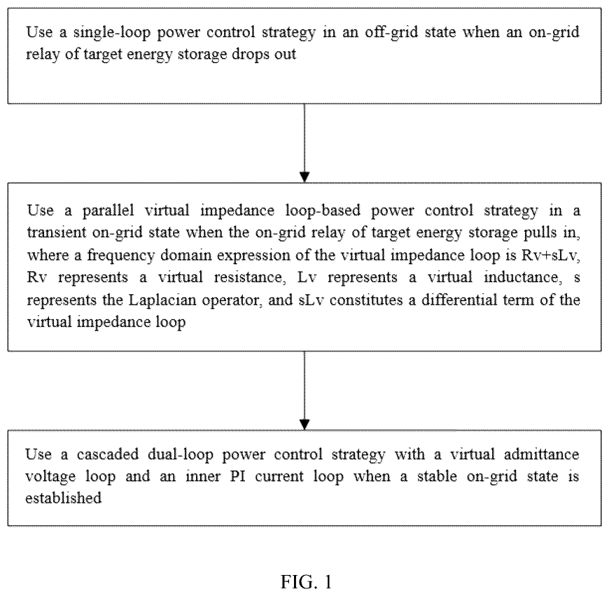

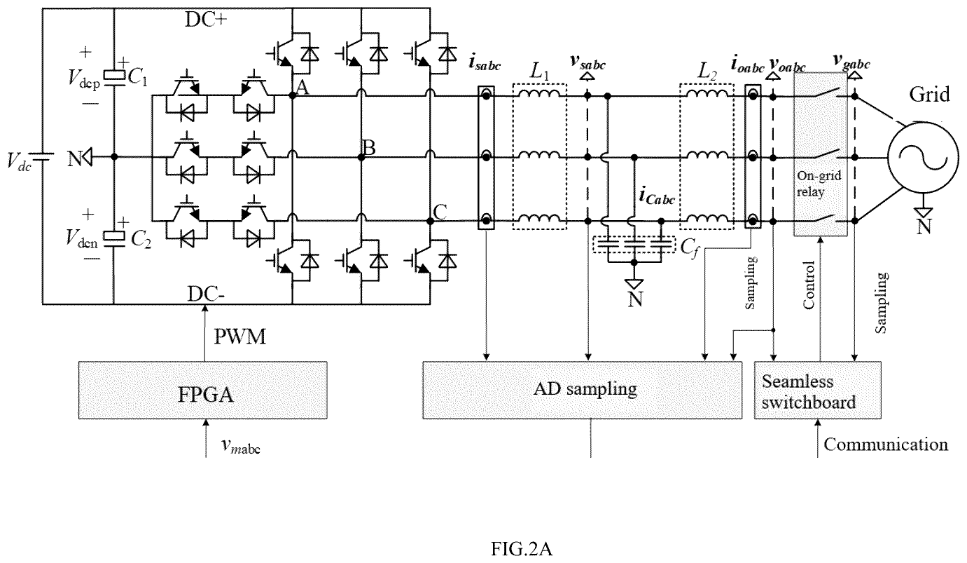

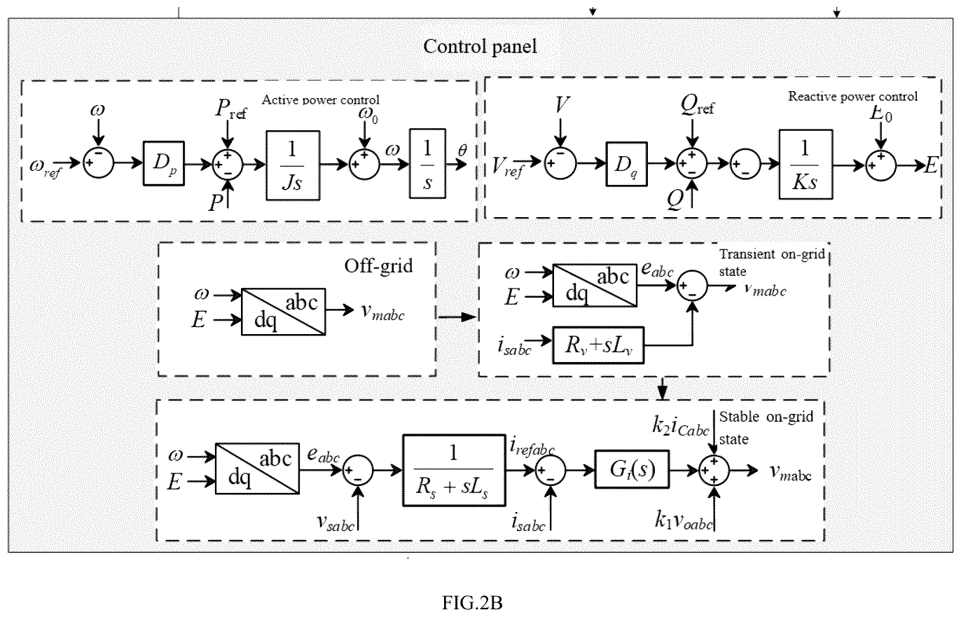

Referring to FIGS. 1-2, the present invention provides a grid-forming energy storage converter on/off-grid switching control method, including the following steps:

S1: using a single-loop power control strategy in an off-grid state when an on-grid relay of target energy storage drops out;

S2: using a parallel virtual impedance loop-based power control strategy in a transient on-grid state when the on-grid relay of target energy storage pulls in, where a frequency domain expression of the virtual impedance loop is Rv+sLv, Rv represents a virtual resistance, Lv represents a virtual inductance, s represents the Laplacian operator, and sLv constitutes a differential term of the virtual impedance loop; and

S3: using a cascaded dual-loop power control strategy with a virtual admittance voltage loop and an inner current loop when a stable on-grid state is established.

In the off-grid state, the converter uses the single-loop power control strategy, which corresponds to the three parts of active power control, reactive power control, and off-grid control in FIGS. 2A and 2B. Optionally, the single-loop power control strategy includes:

an active frequency control loop and a reactive voltage control loop;

an implementation manner of the active frequency control loop is as follows: an output of a difference between a reference frequency ω_{ref} and a control frequency ω after passing through a Dₚ link is superimposed with a difference between a reference active power P_{ref} and an actual output active power P, and then passes through an inertia integration link 1/Js to generate a control frequency ω; a phase reference value θ of a converter output voltage is generated by integrating ω, where the active frequency control loop simulates a rotor motion equation (including an inertia J and a damping Dₚ) and a primary frequency modulation process (including a droop Dₚ) of a synchronous machine; and

an implementation manner of the reactive voltage control loop is as follows: an output of a difference between a reference AC voltage amplitude V_{ref} and an actual AC voltage amplitude V after passing through a D_{q} link is superimposed with a difference between a reference reactive power Q_{ref} and an actual output reactive power Q, and then passes through an integration link 1/Ks to generate an internal potential amplitude E.

Optionally, the single-loop power control strategy includes:

detecting a grid voltage under the single-loop power control strategy, and when a value of the grid voltage is within a preset normal range, carrying out a pre-synchronization algorithm and achieving consistent voltage amplitude and phase between a target converter and the grid in the pre-synchronization algorithm.

Optionally, an implementation manner of the pre-synchronization algorithm is as follows: a phase angle θ_{g} of a grid voltage v_{gabc} is obtained through a phase-locked loop; the grid voltage v_{gabc} in an abc coordinate system is transformed according to the phase angle θ_{g} to obtain v_{gd} and v_{gq} in a dq coordinate system, and a converter output voltage v_{abc} in the abc coordinate system is transformed according to the phase angle θ_{g} to obtain v_{d} and v_{q} in the dq coordinate system; an output ΔV of a difference between v_{gd} and v_{d} after passing through a PI controller is superimposed into a reactive loop to change V_{ref}−V to V_{ref}−V+ΔV; and an output Δω of a difference between v_{gq} and v_{q} after passing through the PI controller is superimposed onto an output end of an active loop integration link 1/Js.

Optionally, the parallel virtual impedance loop-based power control strategy includes:

superimposing a current i_{sabc} flowing through a machine-side inductor L₁ onto a power loop output e_{abc} through a virtual impedance loop Rᵥ+sLᵥ to generate a three-phase modulated wave v_{mabc}.

The control with a virtual admittance voltage loop and an inner current loop is a special case of voltage and current dual-loop control. Optionally, the cascaded dual-loop power control strategy with a virtual admittance voltage loop and an inner current loop includes:

enabling a difference between the power loop output e_{abc} and a converter output voltage v_{sabc} to pass through the virtual admittance voltage loop 1/(Rₛ+sLₛ) to generate a reference current i_{refabc}, and enabling a difference between the reference current i_{refabc} and the machine-side current i_{sabc} to pass through a current controller Gᵢ(s) (including a proportional controller, a resonant controller, and a repetitive controller) and get superimposed with control quantities of active damping and grid voltage feedforward links to generate the three-phase modulated wave v_{mabc}.

The present invention further provides a grid-forming energy storage converter on/off-grid switching control system, including a processor and a non-transitory memory, where:

the non-transitory memory is configured to store a computer program; and

the processor is configured to implement any one of the steps of the grid-forming energy storage converter on/off-grid switching control method when executing the computer program stored on the non-transitory memory.

The above provides a detailed description of the exemplary embodiments of the present invention. It should be understood that those skilled in the art can make many modifications and changes according to the concept of the present invention without creative efforts. Thus, any technical solution that can be obtained by those skilled in the art on the basis of the concept of the present invention through logical analysis, logical inference, or limited experiments on the basis of the prior art should fall within the scope of protection determined by the claims.

What is claimed is:

1. A grid-forming energy storage converter on/off-grid switching control method, comprising the following steps:
S1: using a single-loop power control strategy in an off-grid state when an on-grid relay of target energy storage drops out;
S2: using a parallel virtual impedance loop-based power control strategy in a transient on-grid state when the on-grid relay of target energy storage pulls in, wherein a frequency domain expression of the virtual impedance loop is Rv+sLv, Rv represents a virtual resistance, Lv represents a virtual inductance, s represents the Laplacian operator, and sLv constitutes a differential term of the virtual impedance loop; and
S3: using a cascaded dual-loop power control strategy with a virtual admittance voltage loop and an inner current loop when a stable on-grid state is established.

2. The grid-forming energy storage converter on/off-grid switching control method of claim 1, wherein the single-loop power control strategy comprises:
an active frequency control loop and a reactive voltage control loop;
an implementation manner of the active frequency control loop is as follows: an output of a difference between a reference frequency ω_{ref} and a control frequency ω after passing through a Dₚ link is superimposed with a difference between a reference active power P_{ref} and an actual output active power P, and then passes through an inertia integration link 1/Js to generate a control frequency ω; a phase reference value θ of a converter output voltage is generated by integrating ω, wherein the active frequency control loop simulates a rotor motion equation and a primary frequency modulation process of a synchronous machine, the rotor motion equation comprises an inertia J and a damping Dₚ, and the primary frequency modulation process comprises a droop Dₚ; and
an implementation manner of the reactive voltage control loop is as follows: an output of a difference between a reference AC voltage amplitude V_{ref} and an actual AC voltage amplitude V after passing through a D_{q} link is superimposed with a difference between a reference reactive power Qᵣₑₛ and an actual output reactive power Q, and then passes through an integration link 1/Ks to generate an internal potential amplitude E.

3. The grid-forming energy storage converter on/off-grid switching control method of claim 2, wherein the single-loop power control strategy further comprises:
detecting a grid voltage under the single-loop power control strategy, and when a value of the grid voltage is within a preset normal range, carrying out a pre-synchronization algorithm and achieving consistent voltage amplitude and phase between a target converter and the grid in the pre-synchronization algorithm.

4. The grid-forming energy storage converter on/off-grid switching control method of claim 3, wherein an implementation manner of the pre-synchronization algorithm is as follows:
a phase angle θ_{g} of a grid voltage v_{gabc} is obtained through a phase-locked loop;
the grid voltage v_{gabc} in an abc coordinate system is transformed according to the phase angle θ_{g} to obtain v_{gd} and v_{gq} in a dq coordinate system, and a converter output voltage v_{abc} in the abc coordinate system is transformed according to the phase angle θ_{g} to obtain v_{d} and v_{q} in the dq coordinate system;
an output ΔV of a difference between v_{gd} and v_{d} after passing through a PI controller is superimposed into a reactive loop to change V_{ref}−V to V_{ref}−V+ΔV; and
an output Δω of a difference between v_{gq} and v_{q} after passing through the PI controller is superimposed onto an output end of an active loop integration link 1/Js.

5. The grid-forming energy storage converter on/off-grid switching control method of claim 1, wherein the parallel virtual impedance loop-based power control strategy comprises:
superimposing a current i_{sabc} flowing through a machine-side inductor L₁ onto a power loop output e_{abc} through a virtual impedance loop Rv+sLᵥ to generate a three-phase modulated wave v_{mabc}.

6. The grid-forming energy storage converter on/off-grid switching control method of claim 1, wherein the cascaded dual-loop power control strategy with a virtual admittance voltage loop and an inner current loop comprises:
enabling a difference between a power loop output e_{abc} and a converter output voltage v_{sabc} to pass through a virtual admittance voltage loop 1/(Rₛ+sLₛ) to generate a reference current i_{refabc}, and enabling a difference between the reference current i_{refabc} and a machine-side current i_{sabc} to pass through a current controller Gᵢ(s) and get superimposed with control quantities of active damping and grid voltage feedforward links to generate a three-phase modulated wave v_{mabc}, wherein the current controller Gᵢ(s) comprises a proportional controller, a resonant controller, and a repetitive controller.

7. A grid-forming energy storage converter on/off-grid switching control system, comprising a processor and a non-transitory memory, wherein:
the non-transitory memory is configured to store a computer program; and
the processor is configured to implement the following method steps when executing the computer program stored on the non-transitory memory:
S1: using a single-loop power control strategy in an off-grid state when an on-grid relay of target energy storage drops out;
S2: using a parallel virtual impedance loop-based power control strategy in a transient on-grid state when the on-grid relay of target energy storage pulls in, wherein a frequency domain expression of the virtual impedance loop is Rv+sLv, Rv represents a virtual resistance, Lv represents a virtual inductance, s represents the Laplacian operator, and sLv constitutes a differential term of the virtual impedance loop; and
S3: using a cascaded dual-loop power control strategy with a virtual admittance voltage loop and an inner current loop when a stable on-grid state is established.

8. The grid-forming energy storage converter on/off-grid switching control system of claim 7, wherein the single-loop power control strategy comprises:
an active frequency control loop and a reactive voltage control loop;
an implementation manner of the active frequency control loop is as follows: an output of a difference between a reference frequency ω_{ref} and a control frequency ω after passing through a Dₚ link is superimposed with a difference between a reference active power P_{ref} and an actual output active power P, and then passes through an inertia integration link 1/Js to generate a control frequency ω; a phase reference value θ of a converter output voltage is generated by integrating ω, wherein the active frequency control loop simulates a rotor motion equation and a primary frequency modulation process of a synchronous machine, the rotor motion equation comprises an inertia J and a damping Dₚ, and the primary frequency modulation process comprises a droop Dₚ; and
an implementation manner of the reactive voltage control loop is as follows: an output of a difference between a reference AC voltage amplitude V_{ref} and an actual AC voltage amplitude V after passing through D_{q} link is superimposed with a difference between a reference reactive power Q_{ref} and an actual output reactive power Q, and then passes through an integration link 1/Ks to generate an internal potential amplitude E.

9. The grid-forming energy storage converter on/off-grid switching control system of claim 8, wherein the single-loop power control strategy further comprises:
detecting a grid voltage under the single-loop power control strategy, and when a value of the grid voltage is within a preset normal range, carrying out a pre-synchronization algorithm and achieving consistent voltage amplitude and phase between a target converter and the grid in the pre-synchronization algorithm.

10. The grid-forming energy storage converter on/off-grid switching control system of claim 9, wherein an implementation manner of the pre-synchronization algorithm is as follows:
a phase angle θ_{g} of a grid voltage v_{gabc} is obtained through a phase-locked loop;
the grid voltage v_{gabc} in an abc coordinate system is transformed according to the phase angle θ_{g} to obtain v_{gd} and v_{gq} in a dq coordinate system, and a converter output voltage v_{abc} in the abc coordinate system is transformed according to the phase angle θ_{g} to obtain v_{d} and v_{q} in the dq coordinate system;
an output ΔV of a difference between v_{gd} and v_{d} after passing through a PI controller is superimposed into a reactive loop to change V_{ref}−V to V_{ref}−V+ΔV; and
an output Δω of a difference between v_{gq} and v_{q} after passing through the PI controller is superimposed onto an output end of an active loop integration link 1/Js.

11. The grid-forming energy storage converter on/off-grid switching control system of claim 7, wherein the parallel virtual impedance loop-based power control strategy comprises:
superimposing a current i_{sabc} flowing through a machine-side inductor L₁ onto a power loop output e_{abc} through a virtual impedance loop Rᵥ+sLᵥ to generate a three-phase modulated wave v_{mabc}.

12. The grid-forming energy storage converter on/off-grid switching control system of claim 7, wherein the cascaded dual-loop power control strategy with a virtual admittance voltage loop and an inner current loop comprises:
enabling a difference between a power loop output e_{abc} and a converter output voltage v_{sabc} to pass through a virtual admittance voltage loop 1/(Rₛ+sLₛ) to generate a reference current i_{refabc}, and enabling a difference between the reference current i_{refabc} and a machine-side current i_{sabc} to pass through a current controller Gᵢ(s) and get superimposed with control quantities of active damping and grid voltage feedforward links to generate a three-phase modulated wave v_{mabc}, wherein the current controller Gᵢ(s) comprises a proportional controller, a resonant controller, and a repetitive controller.
